(19) United States
(12) Patent Application Publication
(10) Pub. No.: US 2017/0322680 A1
(43) Pub. Date: Nov. 9, 2017

(54) METHOD AND APPARATUS FOR SETTING BACKGROUND OF UI CONTROL, AND TERMINAL

(71) Applicant: Huawei Technologies Co., Ltd., Shenzhen, Guangdong (CN)

(72) Inventor: Xiangpo Yang, Shenzhen (CN)

(73) Assignee: Huawei Technologies Co., Ltd., Shenzhen, Guangdong (CN)

(21) Appl. No.: 15/329,487

(22) PCT Filed: Jul. 30, 2014
(86) PCT No.: PCT/CN2014/083337

§ 371 Date: Jan. 26, 2017

(51) Int. Cl. G06F 3/0481

(52) U.S. Cl. CPC G06F 3/0481

(57) ABSTRACT

Embodiments of the present invention disclose a method and an apparatus for setting a background of a UI control. The method includes : acquiring, after a wallpaper of a terminal is updated, a fuzzy wallpaper obtained after fuzzy processing is performed on the updated wallpaper; capturing, according to a location of the UI control on a screen of the terminal, a wallpaper area block from the acquired fuzzy wallpaper; and setting the one captured wallpaper area block to a background of the UI control. In the embodiments of the present invention, the background of the UI control of the terminal can be enabled to dynamically change as the wallpaper changes, thereby enhancing flexibility and variability of a background image of the UI control.

### CROSS REFERENCE TO RELATED APPLICATIONS

The present application claims priority under 35 U.S.C. §365 to International Patent Application No. PCT/CN2014/083337 filed Jul. 30, 2014 which is incorporated herein by reference in its entirety.

### TECHNICAL FIELD

The present invention relates to the field of electronic technologies, and in particular, to a method and an apparatus for setting a background of a UI control, and a terminal.

### BACKGROUND

Currently, a user interface (User Interface, UI) control used by each application of a portable terminal (for example, a mobile phone) basically uses a single invariable picture as a control background, and each manufacturer basically uses a single picture of the manufacturer as a control background. Therefore, disadvantages, such as invariability, monotony, and inflexibility, commonly exist in backgrounds of current UI controls.

### SUMMARY

Embodiments of the present invention provide a method and an apparatus for setting a background of a UI control, and a terminal, which can enable the background of the UI control of the terminal to dynamically change as a wallpaper changes, thereby enhancing flexibility and variability of a background image of the UI control.

A first aspect of the present invention provides a method for setting a background of a user interface UI control, which may include:

acquiring, after a wallpaper of a terminal is updated, a fuzzy wallpaper obtained after fuzzy processing is performed on the updated wallpaper;

capturing, according to a location of the UI control on a screen of the terminal, a wallpaper area block from the acquired fuzzy wallpaper; and

setting the one captured wallpaper area block to a background of the UI control.

With reference to the first aspect, in a first feasible implementation manner, the wallpaper includes a live wallpaper, and the acquiring a fuzzy wallpaper obtained after fuzzy processing is performed on the updated wallpaper includes:

acquiring a fuzzy wallpaper obtained after fuzzy processing is performed on each changing state of an updated live wallpaper.

With reference to the first aspect or the first feasible implementation manner of the first aspect, in a second feasible implementation manner, the capturing, according to a location of the UI control on a screen of the terminal, a wallpaper area block from the acquired fuzzy wallpaper includes:

capturing, according to a location of the UI control on a touchscreen of the terminal, a wallpaper area block at a location corresponding to the location of the UI control from the acquired fuzzy wallpaper.

With reference to any one of the first aspect to the second feasible implementation manner of the first aspect, in a third feasible implementation manner, when a wallpaper area block is captured from the acquired fuzzy wallpaper, multiple wallpaper area blocks are captured; and

the setting the one captured wallpaper area block to a background of the UI control includes:

setting any wallpaper area block of the multiple captured wallpaper area blocks to the background of the UI control; or

setting the multiple wallpaper area blocks to the background of the UI control one by one according to a preset polling policy.

With reference to any one of the first aspect to the third feasible implementation manner of the first aspect, in a fourth feasible implementation manner, the method of the embodiments of the present invention further includes:

before the acquiring, after a wallpaper of a terminal is updated, a fuzzy wallpaper obtained after fuzzy processing is performed on the updated wallpaper, performing fuzzy processing on the updated wallpaper; or

when the terminal generates one wallpaper, performing fuzzy processing on the generated wallpaper.

With reference to the fourth feasible implementation manner of the first aspect, in a fifth feasible implementation manner, the method of the embodiments of the present invention further includes:

caching the fuzzy wallpaper obtained after the fuzzy processing is performed in internal memory of the terminal or saving the fuzzy wallpaper in a memory of the terminal, so as to acquire the fuzzy wallpaper obtained after fuzzy processing is performed on the updated wallpaper.

With reference to any one of the first aspect to the fifth feasible implementation manner of the first aspect, in a sixth feasible implementation manner, before the capturing, according to a location of the UI control on a screen of the terminal, a wallpaper area block from the acquired fuzzy wallpaper, the method further includes:

sampling the acquired fuzzy wallpaper and forming a new fuzzy wallpaper from sampled data; and

during the capturing, according to a location of the UI control on a screen of the terminal, a wallpaper area block from the acquired fuzzy wallpaper, capturing a wallpaper area block from the new fuzzy wallpaper formed from the sampled data.

A second aspect of the present invention provides an apparatus for setting a background of a user interface UI control, which may include:

an acquisition module, configured to acquire, after a wallpaper of a terminal is updated, a fuzzy wallpaper obtained after fuzzy processing is performed on the updated wallpaper;

an image capturing module, configured to capture, according to a location of the UI control on a screen of the terminal, a wallpaper area block from the fuzzy wallpaper acquired by the acquisition module; and

a setting module, configured to set the one wallpaper area block captured by the image capturing module to a background of the UI control.

With reference to the second aspect, in a first feasible implementation manner, the wallpaper includes a live wallpaper, and the acquisition module is specifically configured to: after the wallpaper of the terminal is updated, acquire a fuzzy wallpaper obtained after fuzzy processing is performed on each changing state of an updated live wallpaper

With reference to the second aspect or the first feasible implementation manner of the second aspect, in a second feasible implementation manner, the image capturing module is specifically configured to capture, according to a location of the UI control on a touchscreen of the terminal, a wallpaper area block at a location corresponding to the location of the UI control from the fuzzy wallpaper acquired by the acquisition module.

With reference to any one of the second aspect to the second feasible implementation manner of the second aspect, in a third feasible implementation manner, when the image capturing module captures a wallpaper area block from the fuzzy wallpaper acquired by the acquisition module, multiple wallpaper area blocks are captured; and

the setting module is specifically configured to: set any wallpaper area block of the multiple captured wallpaper area blocks to the background of the UI control; or set the multiple wallpaper area blocks to the background of the UI control one by one according to a preset polling policy.

With reference to any one of the second aspect to the third feasible implementation manner of the second aspect, in a fourth feasible implementation manner, the apparatus further includes:

a fuzzy processing module, configured to: before the acquisition module acquires, after the wallpaper of the terminal is updated, a fuzzy wallpaper obtained after fuzzy processing is performed on the updated wallpaper, perform fuzzy processing on the updated wallpaper; or, when the terminal generates one wallpaper, perform fuzzy processing on the generated wallpaper.

With reference to the fourth feasible implementation manner of the second aspect, in a fifth feasible implementation manner, the apparatus further includes:

a storage control module, configured to cache the fuzzy wallpaper obtained after the fuzzy processing is performed by the fuzzy processing module in internal memory of the terminal or save the fuzzy wallpaper in a memory of the terminal.

With reference to any one of the second aspect to the fifth feasible implementation manner of the second aspect, in a sixth feasible implementation manner, the apparatus further includes:

a sampling module, configured to: sample the fuzzy wallpaper acquired by the acquisition module and form a new fuzzy wallpaper from sampled data, where

when the image capturing module captures, according to a location of the UI control on a screen of the terminal, a wallpaper area block from the acquired fuzzy wallpaper, the image capturing module captures a wallpaper area block from the new fuzzy wallpaper formed from the sampled data.

A third aspect of the present invention provides a terminal, which may include: an input/output apparatus, a memory, and a processor, where the input/output apparatus, the memory, and the processor are connected by using a bus;

the input/output apparatus is configured to interact with a user and receive an instruction input by the user or output data to the user;

the memory is configured to save program data having various functions; and

the processor is configured to call program data stored in the memory and perform the following operations:

acquiring, after a wallpaper of a terminal is updated, a fuzzy wallpaper obtained after fuzzy processing is performed on the updated wallpaper;

capturing, according to a location of the UI control on a screen of the terminal, a wallpaper area block from the acquired fuzzy wallpaper; and

setting the one captured wallpaper area block to a background of the UI control.

With reference to the third aspect, in a first feasible implementation manner, the wallpaper includes a live wallpaper, and the processor performs the operation of acquiring a fuzzy wallpaper obtained after fuzzy processing is performed on the updated wallpaper, which specifically includes:

acquiring a fuzzy wallpaper obtained after fuzzy processing is performed on each changing state of an updated live wallpaper.

With reference to the third aspect or the first feasible implementation manner of the third aspect, in a second feasible implementation manner, the processor performs the operation of capturing, according to a location of the UI control on a screen of the terminal, a wallpaper area block from the acquired fuzzy wallpaper, which specifically includes:

capturing, according to a location of the UI control on a touchscreen of the terminal, a wallpaper area block at a location corresponding to the location of the UI control from the acquired fuzzy wallpaper.

With reference to any one of the third aspect to the second feasible implementation manner of the third aspect, in a third feasible implementation manner, when the processor performs the operation of capturing a wallpaper area block from the acquired fuzzy wallpaper, multiple wallpaper area blocks are captured; and

then the processor performs the operation of setting the one captured wallpaper area block to a background of the UI control, which specifically includes:

setting any wallpaper area block of the multiple captured wallpaper area blocks to the background of the UI control; or

setting the multiple wallpaper area blocks to the background of the UI control one by one according to a preset polling policy.

With reference to any one of the third aspect to the third feasible implementation manner of the third aspect, in a fourth feasible implementation manner, the processor further performs the following operation:

before the acquiring, after a wallpaper of a terminal is updated, a fuzzy wallpaper obtained after fuzzy processing is performed on the updated wallpaper, performing fuzzy processing on the updated wallpaper; or

when the terminal generates one wallpaper, performing fuzzy processing on the generated wallpaper.

With reference to the fourth feasible implementation manner of the third aspect, in a fifth feasible implementation manner, the processor further performs the following operation:

caching the fuzzy wallpaper obtained after the fuzzy processing is performed in internal memory of the terminal or saving the fuzzy wallpaper in a memory of the terminal, so as to acquire the fuzzy wallpaper obtained after fuzzy processing is performed on the updated wallpaper.

With reference to any one of the third aspect to the fifth feasible implementation manner of the third aspect, in a sixth feasible implementation manner, before the processor performs the operation of capturing, according to a location of the UI control on a screen of the terminal, a wallpaper area block from the acquired fuzzy wallpaper, the processor further performs the following operations:

sampling the acquired fuzzy wallpaper and forming a new fuzzy wallpaper from sampled data; and

then, when the processor performs the operation of capturing, according to a location of the UI control on a screen of the terminal, a wallpaper area block from the acquired fuzzy wallpaper, capturing a wallpaper area block from the new fuzzy wallpaper formed from the sampled data.

A fourth aspect of the present invention provides a computer storage medium, where a program can be stored in the computer storage medium, and when the program is executed, some or all steps of the method of each embodiment of the present invention may be included.

It can be seen from above that, in the embodiments of the present invention, a background of a UI control is set to be dynamically updated and set along with a wallpaper of a terminal. In this way, when the wallpaper of the terminal changes, the background of the UI control may also change in real time. Therefore, flexibility and variability of a background image of the UI control are enhanced in the embodiments of the present invention.

### BRIEF DESCRIPTION OF THE DRAWINGS

FIG. 1 is a schematic flowchart of an embodiment of a method for setting a background of a UI control according to an embodiment of the present invention;

FIG. 2a to FIG. 2c are schematic principle diagrams of capturing a wallpaper area block from a fuzzy wallpaper according to an embodiment of the present invention;

FIG. 3 is a schematic flowchart of another embodiment of a method for setting a background of a UI control according to an embodiment of the present invention;

FIG. 4 is a schematic structural composition diagram of an embodiment of an apparatus for setting a background of a UI control according to an embodiment of the present invention;

FIG. 5 is a schematic structural composition diagram of another embodiment of an apparatus for setting a background of a UI control according to an embodiment of the present invention;

FIG. 6 is a schematic structural composition diagram of another embodiment of an apparatus for setting a background of a UI control according to an embodiment of the present invention;

FIG. 7 is a schematic structural composition diagram of another embodiment of an apparatus for setting a background of a UI control according to an embodiment of the present invention; and

FIG. 8 is a schematic structural composition diagram of an embodiment of a terminal according to the present invention.

### DETAILED DESCRIPTION

In embodiments of the present invention, a background of a UI control is set to be dynamically updated and set along with a wallpaper of a terminal. In this way, when the wallpaper of the terminal changes, the background of the UI control may also change in real time. Therefore, flexibility and variability of a background image of the UI control are enhanced in the embodiments of the present invention. Furthermore, in the embodiments of the present invention, to avoid performing fuzzy processing on a wallpaper only when a fuzzy wallpaper is acquired each time, when one wallpaper is generated, fuzzy processing may be performed on the generated wallpaper, and the fuzzy wallpaper obtained after the fuzzy processing is cached in internal memory of the terminal or saved in a memory of the terminal. In this way, when a fuzzy wallpaper needs to be acquired to serve as the background of the UI control, the fuzzy wallpaper may be directly acquired and an area block of the fuzzy wallpaper may be captured, so that a processing time for setting, by a system, the background of the UI control can be reduced. Moreover, loss of the internal memory of the terminal may be reduced by using the memory to save the fuzzy wallpaper. Besides, in the embodiments of the present invention, a black mask may also be superposed on the captured wallpaper area to ensure that the UI control on the wallpaper can be normally displayed on a wallpaper of any color. In addition, in the embodiments of the present invention, when a wallpaper area is captured, the whole fuzzy wallpaper may be first sampled, and a size of the wallpaper area captured after the sampling is smaller, which may further reduce the loss of the internal memory of the terminal and save space of the internal memory.

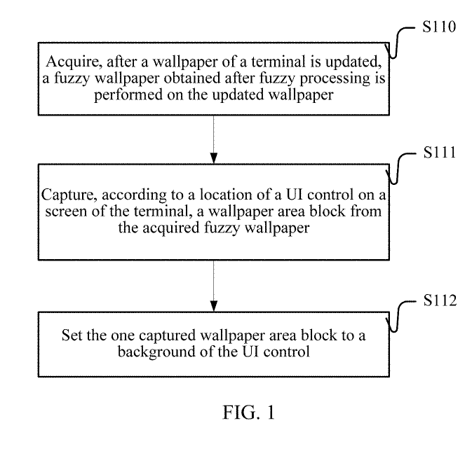

FIG. 1 is a schematic flowchart of an embodiment of a method for setting a background of a UI control according to an embodiment of the present invention. As described in FIG. 1, the method for setting a background of a UI control according to the present invention may include:

Step S110: Acquire, after a wallpaper of a terminal is updated, a fuzzy wallpaper obtained after fuzzy processing is performed on the updated wallpaper.

In specific implementation, the terminal according to this embodiment of the present invention includes any device with a built-in UI control. The device includes, but is not limited to, a mobile phone, a tablet computer, a wearable device, or the like.

In some feasible implementation manners, after the wallpaper of the terminal is updated, in this embodiment of the present invention, fuzzy processing may be performed on the updated wallpaper. In addition, the fuzzy wallpaper obtained after the fuzzy processing may be cached in internal memory of the terminal or saved in a memory of the terminal, so as to acquire the fuzzy wallpaper obtained after fuzzy processing is performed on the updated wallpaper.

In some other feasible embodiments, to avoid performing fuzzy processing on a wallpaper only when a fuzzy wallpaper is acquired each time, in this embodiment of the present invention, when a terminal generates one wallpaper (manufacturing and finishing one wallpaper according to wallpaper software, or downloading one wallpaper from a third party to a terminal, or another manner of enabling a terminal to acquire a wallpaper that the terminal does not have can be understood as generating, by a terminal, one wallpaper), fuzzy processing may be performed immediately on the wallpaper and the fuzzy wallpaper obtained after fuzzy processing may be cached in internal memory of the terminal or saved in a memory of the terminal. In this way, when a fuzzy wallpaper needs to be acquired to serve as the background of the UI control, the fuzzy wallpaper may be directly acquired and an area block of the fuzzy wallpaper may be captured, so that a processing time for setting, by a system, the background of the UI control can be reduced.

In specific implementation, the memory in this embodiment of the present invention may include, but is not limited to, a volatile memory (such as a RAM), a nonvolatile memory (such as a ROM or a flash memory), or a combination thereof.

In specific implementation, the wallpaper of this embodiment of the present invention may include two types, namely, a static wallpaper and a live wallpaper. With regard to a static wallpaper, in step S110, a fuzzy wallpaper obtained after fuzzy processing is performed on an updated static wallpaper can be directly acquired; with regard to a live wallpaper, because the wallpaper is dynamically changeable, in step S110, a fuzzy wallpaper obtained after fuzzy processing is performed on each changing state of an updated live wallpaper can be acquired. For example, if the live wallpaper includes three changing states, which are m1, m2, and m3, respectively, and each changing state corresponds to a wallpaper image of the live wallpaper at a different moment, in step S110, fuzzy wallpapers obtained after fuzzy processing is performed on changing states m1, m2, and m3 of a live wallpaper b separately at three moments may be acquired.

In specific implementation, in this embodiment of the present invention, when fuzzy processing is performed on the wallpaper, a fuzzy processing manner, such as Gaussian fuzzy processing, may be used. The Gaussian fuzzy processing is used as an example. In this embodiment of the present invention, when Gaussian fuzzy processing is performed, with regard to a static wallpaper, image scaling may be performed on the basis of an original image to scale down an image to a fixed size, then Gaussian fuzzy processing is performed on the scaled-down image (from a perspective of mathematics, a process of performing Gaussian fuzzy processing on an image is performing a convolution on the image and normal distribution; because the normal distribution is also referred to as Gaussian distribution, this technique is referred to as Gaussian fuzzy processing), and subsequently, the image obtained after the Gaussian fuzzy processing is recovered to a size of the original wallpaper. Moreover, with regard to a live wallpaper, a wallpaper thumbnail of each changing state of the live wallpaper may be separately captured, image scaling is performed on an image presented by the thumbnail on the basis of an original image to scale down the image to a fixed size, then Gaussian fuzzy processing is performed on the scaled-down image (the principle is the same as the preceding one), and subsequently, the image obtained after the Gaussian fuzzy processing is recovered to a size of the original wallpaper.

It should be understood that in this embodiment of the present invention, after a wallpaper of a terminal is updated, a fuzzy wallpaper obtained after fuzzy processing is performed on the updated wallpaper is acquired. The updating a wallpaper of a terminal includes determining, by the terminal, a to-be-updated wallpaper, that is, once the terminal determines a to-be-updated wallpaper, the terminal can acquire a fuzzy wallpaper obtained after fuzzy processing is performed on the to-be-updated wallpaper. In this case, the terminal may determine only the to-be-updated wallpaper and have not yet updated the wallpaper or be updating the wallpaper, which also falls within the protection scope of this embodiment of the present invention.

Step S111: Capture, according to a location of the UI control on a screen of the terminal, a wallpaper area block from the acquired fuzzy wallpaper.

In specific implementation, the terminal may include one or more UI controls, a location of each UI control on the screen of the terminal may be different, and a location of a same UI control on the screen of the terminal may also change as the time changes.

In specific implementation, in this embodiment of the present invention, when a wallpaper area block is captured from the acquired fuzzy wallpaper according to a location of the UI control on the screen of the terminal, a wallpaper area block at a location corresponding to the location of the UI control may be captured from the acquired fuzzy wallpaper according to a location of the UI control on a touchscreen of the terminal; or, a wallpaper area block at a location that does not correspond to the location of the UI control is captured from the acquired fuzzy wallpaper according to a location of the UI control on a touchscreen of the terminal. A wallpaper area block at a location that does not correspond to the location.

In a feasible implementation manner, in this embodiment of the present invention, after a wallpaper area block is captured from the fuzzy wallpaper in step S111, a black mask may also be superposed on the captured wallpaper area block, so that it can be ensured that the UI control on the wallpaper can be normally displayed on a wallpaper of any color (for example, a pure white wallpaper).

Step S112: Set the one captured wallpaper area block to a background of the UI control.

In specific implementation, in this embodiment of the present invention, one or more wallpaper area blocks may be captured from a fuzzy wallpaper in step S111, and when one wallpaper area block is captured, the wallpaper area block may be directly used in the setting in step S112. When multiple (two or more) wallpaper area blocks are captured, in this embodiment of the present invention, any wallpaper area block of the multiple captured wallpaper area blocks may be set to a background of the UI control in step S112; or, the multiple wallpaper area blocks are set to a background of the UI control one by one according to a preset polling policy. The polling policy may include performing alternation in turn by time. For example, when it is assumed that three wallpaper area blocks (which are f0, f1, and f2, respectively) are captured, a policy of using the three wallpaper area blocks in turn as a background of a control a is: in a time segment t0, the wallpaper area block f0 is used as the background of the control a; in a time segment t1, the wallpaper area block f1 is used as the background of the control a; and in a time segment t2, the wallpaper area block f2 is used as the background of the control a. Alternatively, the polling policy may include performing alternation in turn according to different locations of a UI control. For example, wallpaper area blocks are still f0, f1, and f2, and the policy of performing polling according to the locations may be: when a control a is at a location (x0, y0), the wallpaper area block f0 is used as a background of the control a; when the control a moves to a location (x1, y1), the wallpaper area block f1 is used as the background of the control a; and when the control a is at a location (x2, y2), the wallpaper area block f2 is used as the background of the control a. Alternatively, the polling policy may include any other manner that can implement alternation, for example, for a live wallpaper, because the wallpaper is dynamically changeable, in this embodiment of the present invention, wallpaper area blocks of the live wallpaper in wallpaper states at different moments may be used as alternation materials of a background of a UI control. For example, if wallpaper area blocks of a live wallpaper in a top area of the live wallpaper at three moments, namely, t1, t0, and t2, are f00, f01, and f02, respectively, it may be set: when a control a is at a location (x0, y0), the wallpaper area block f00 is used as a background of the control a; when the control a moves to a location (x1, y1), the wallpaper area block f01 is used as the background of the control a; and when the control a is at a location (x2, y2), the wallpaper area block f02 is used as the background of the control a.

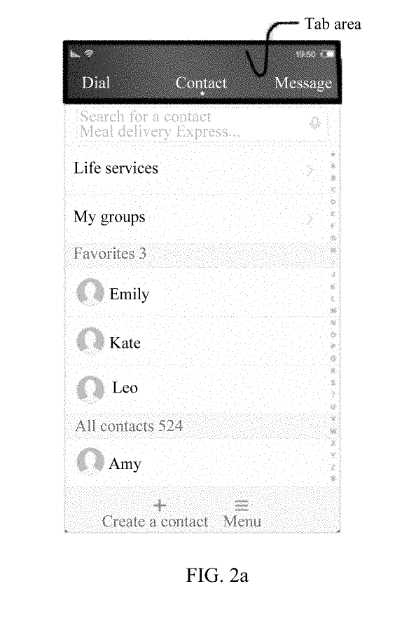

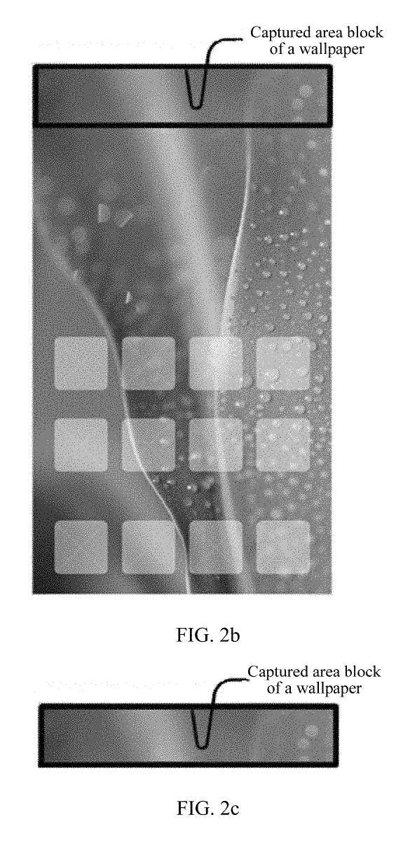

In this embodiment of the present invention, a location of a UI control may be indicated by using absolute coordinates of the UI control on the screen of the terminal or corner coordinates of an area block at which the UI control is located. In addition, a wallpaper area block corresponding to the location of the UI control or a wallpaper area block at a location that does not correspond to the location of the UI control is captured from the fuzzy wallpaper according to the extracted absolute coordinates and corner coordinates. Capturing one wallpaper area block at a corresponding location as the background of the UI control is used below as an example for description. FIG. 2a to FIG. 2c are used as an example, where in FIG. 2a, a tab area is a display area of a UI control of an Android system (this area includes three selection tags, such as Dial, Contact, and Message, as UI controls), and in this example, coordinates of four corners of the tab area may be used to indicate locations of the UI controls of the whole tab area. Therefore, in FIG. 2b, in this embodiment of the present invention, an area enclosed by coordinates that are the same as the coordinates of the four corners of the tab area may be captured from the whole acquired fuzzy wallpaper to serve as a captured wallpaper area block (specifically, an area shown in a black block in FIG. 2b), and a finally captured wallpaper area block corresponding to the tab area is shown in FIG. 2c. A capturing manner by using the absolute coordinates is similar to a capturing manner by using the corner coordinates, and details are not described herein again.

In a feasible implementation manner, in step S112, the one captured wallpaper area block may be called by using a UI control background callback function to serve as the background of the UI control. In specific implementation, the background callback function is a type of function for calling internal data of a terminal, and this background callback function is used for instructing an internal setting module of the terminal to set the one captured wallpaper area block to a background of the UI control. Certainly, in specific implementation, the internal setting module of the terminal may also be instructed by using some other terminal call functions to set the one captured wallpaper area block to a background of the UI control, and the call functions are not described one by one by using examples herein.

It can be seen from above that, in this embodiment, a background of a UI control is set to be dynamically updated and set along with a wallpaper of a terminal. In this way, when the wallpaper of the terminal changes, the background of the UI control may also change in real time. Therefore, flexibility and variability of a background image of the UI control are enhanced in this embodiment of the present invention. Furthermore, in this embodiment of the present invention, to avoid performing fuzzy processing on a wallpaper only when a fuzzy wallpaper is acquired each time, when one wallpaper is generated, fuzzy processing may be performed on the generated wallpaper, and the fuzzy wallpaper obtained after the fuzzy processing is cached in internal memory of the terminal or saved in a memory of the terminal. In this way, when a fuzzy wallpaper needs to be acquired to serve as the background of the UI control, the fuzzy wallpaper may be directly acquired and an area block of the fuzzy wallpaper may be captured, so that a processing time for setting, by a system, the background of the UI control can be reduced. Moreover, loss of the internal memory of the terminal may be reduced by using the memory to save the fuzzy wallpaper. Besides, in the embodiments of the present invention, a black mask may also be superposed on the captured wallpaper area to ensure that the UI control on the wallpaper can be normally displayed on a wallpaper of any color.

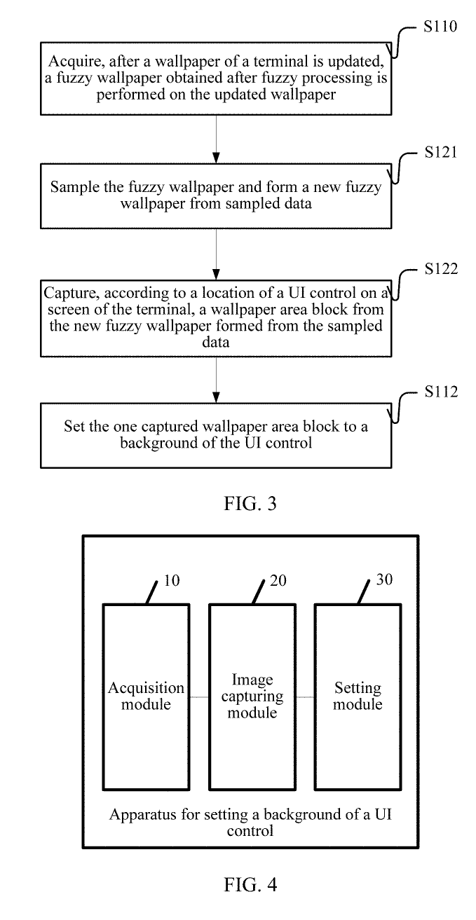

FIG. 3 is a schematic flowchart of another embodiment of a method for setting a background of a UI control according to an embodiment of the present invention. As shown in FIG. 3, a difference between this embodiment and the embodiment shown in FIG. 1 may include:

Steps S121 and S122 are performed after step S110, and then step S112 is further performed.

S121 and S122 are specifically as follows:

Step S121: Sample the fuzzy wallpaper and form a new fuzzy wallpaper from sampled data. In specific implementation, the sampling refers to performing equal-interval or unequal-interval sampling on all pixel points of the fuzzy wallpaper, and a new fuzzy wallpaper is formed from sampled data. An advantage of this step is reducing an overall size of the fuzzy wallpaper used for capturing a wallpaper area block, so as to greatly save space of internal memory.

Step S122: Capture, according to a location of the UI control on a screen of the terminal, a wallpaper area block from the new fuzzy wallpaper formed from the sampled data.

In specific implementation, a manner of capturing a wallpaper area block in step S122 is basically the same as that in step S111, but is different from that in step S111 only in capturing an area block from a new fuzzy wallpaper formed from sampled data, and capturing an area block from a wallpaper that is not sampled. Therefore, specific implementation of step S122 is not described herein again.

Step S110 in this embodiment may be the same as step S110 in FIG. 1, and details are not described herein again.

Step S112 in this embodiment may be the same as step S112 in FIG. 1, and details are not described herein again.

In this embodiment, when a wallpaper area is captured, the whole fuzzy wallpaper is first sampled, and a wallpaper area block is captured from a new fuzzy wallpaper formed from sampled data, so that a size of the wallpaper area block captured after the sampling is smaller, which may further reduce loss of the internal memory of the terminal and save space of the internal memory.

On the basis of the foregoing method embodiment, embodiments of the present invention further provide an apparatus that can be configured to implement the foregoing method embodiment, and an embodiment of the apparatus according to an embodiment of the present invention is described below by using an example.

FIG. 4 is a schematic structural composition diagram of an embodiment of an apparatus for setting a background of a UI control according to an embodiment of the present invention. As described in FIG. 4, the apparatus for setting a background of a UI control according to the present invention may at least include an acquisition module 10, an image capturing module 20, and a setting module 30.

The acquisition module 10 is configured to acquire, after a wallpaper of a terminal is updated, a fuzzy wallpaper obtained after fuzzy processing is performed on the updated wallpaper.

The image capturing module 20 is configured to capture, according to a location of the UI control on a screen of the terminal, a wallpaper area block from the fuzzy wallpaper acquired by the acquisition module 10.

The setting module 30 is configured to set the one wallpaper area block captured by the image capturing module 20 to a background of the UI control.

In specific implementation, the terminal according to this embodiment of the present invention includes any device with a built-in UI control. The device includes, but is not limited to, a mobile phone, a tablet computer, a wearable device, or the like. The apparatus for setting a background of a UI control of this embodiment of the present invention may be an internal apparatus of the terminal or an external apparatus connected to the terminal. When the apparatus for setting a background of a UI control is an external apparatus, the apparatus for setting a background of a UI control may establish a connection to and perform communication with the terminal by using some general device interfaces.

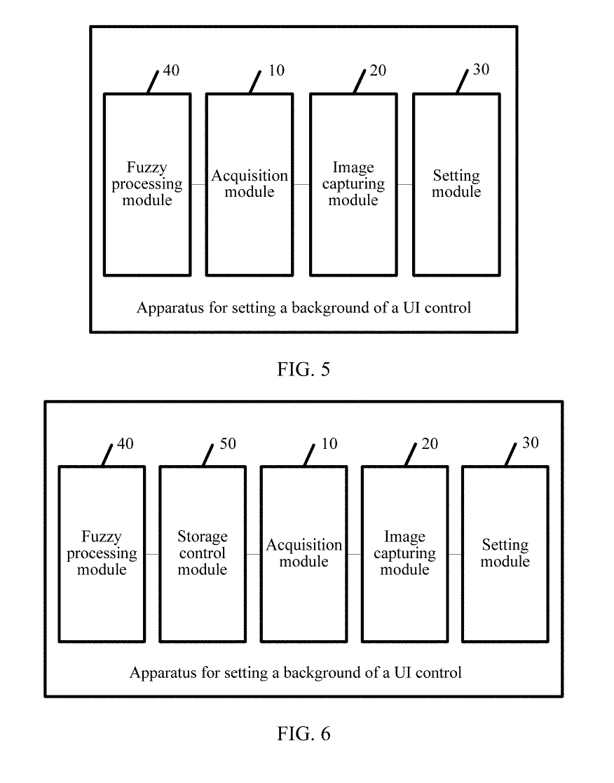

In some feasible implementation manners, as shown in FIG. 5, the apparatus of this embodiment of the present invention may further include: a fuzzy processing module 40, configured to: before the acquisition module 10 acquires, after the wallpaper of the terminal is updated, a fuzzy wallpaper obtained after fuzzy processing is performed on the updated wallpaper, perform fuzzy processing on the updated wallpaper; or, when the terminal generates one wallpaper (manufacturing and finishing one wallpaper according to wallpaper software, or downloading one wallpaper from a third party to a terminal, or another manner of enabling a terminal to acquire a wallpaper that the terminal does not have can be understood as generating, by a terminal, one wallpaper), perform fuzzy processing on the generated wallpaper.

In specific implementation, to avoid performing fuzzy processing on a wallpaper only when a fuzzy wallpaper is acquired each time, in this embodiment of the present invention, when the terminal generates one wallpaper, fuzzy processing may be performed immediately on the wallpaper. In this way, when a fuzzy wallpaper needs to be acquired to serve as the background of the UI control, the fuzzy wallpaper may be directly acquired and an area block of the fuzzy wallpaper may be captured, so that a processing time for setting, by a system, the background of the UI control can be reduced.

In specific implementation, the wallpaper of this embodiment of the present invention may include two types, namely, a static wallpaper and a live wallpaper. With regard to a static wallpaper, the acquisition module 10 may directly acquire a fuzzy wallpaper obtained after fuzzy processing is performed on an updated static wallpaper; with regard to a live wallpaper, because the wallpaper is dynamically changeable, the acquisition module 10 may acquire a fuzzy wallpaper obtained after fuzzy processing is performed on each changing state of an updated live wallpaper. For example, if the live wallpaper includes three changing states, which are m1, m2, and m3, respectively, and each changing state corresponds to a wallpaper image of the live wallpaper at a different moment, the acquisition module 10 may acquire a fuzzy wallpapers obtained after fuzzy processing is performed on changing states m1, m2, and m3 of a live wallpaper b separately at three moments.

In specific implementation, in this embodiment of the present invention, when fuzzy processing is performed on the wallpaper, a common fuzzy processing manner, such as Gaussian fuzzy processing, may be used. The Gaussian fuzzy processing is used as an example. In this embodiment of the present invention, when Gaussian fuzzy processing is performed, with regard to a static wallpaper, image scaling may be performed on the basis of an original image to scale down an image to a fixed size, then Gaussian fuzzy processing is performed on the scaled-down image (from a perspective of mathematics, a process of performing Gaussian fuzzy processing on an image is performing a convolution on the image and normal distribution; because the normal distribution is also referred to as Gaussian distribution, this technique is referred to as Gaussian fuzzy processing), and subsequently, the image obtained after the Gaussian fuzzy processing is recovered to a size of the original wallpaper. Moreover, with regard to a live wallpaper, a wallpaper thumbnail of each changing state of the live wallpaper may be separately captured, image scaling is performed on an image presented by the thumbnail on the basis of an original image to scale down the image to a fixed size, then Gaussian fuzzy processing is performed on the scaled-down image (the principle is the same as the preceding one), and subsequently, the image obtained after the Gaussian fuzzy processing is recovered to a size of the original wallpaper.

In some feasible implementation manners, as shown in FIG. 6, the apparatus for setting a background of a UI control of the embodiments of the present invention further includes:

a storage control module 50, configured to cache the fuzzy wallpaper obtained after the fuzzy processing is performed by the fuzzy processing module 40 in internal memory of the terminal or save the fuzzy wallpaper in a memory of the terminal.

In specific implementation, the memory in this embodiment of the present invention may include, but is not limited to, a volatile memory (such as a RAM), a nonvolatile memory (such as a ROM or a flash memory), or a combination thereof.

In this embodiment of the present invention, an advantage of caching a fuzzy wallpaper in a memory of a terminal is that loss of the internal memory of the terminal can be reduced.

In specific implementation, the terminal may include one or more UI controls, a location of each UI control on the screen of the terminal may be different, and a location of a same UI control on the screen of the terminal may also change as the time changes.

In specific implementation, in this embodiment of the present invention, when the image capturing module 20 captures a wallpaper area block from the acquired fuzzy wallpaper according to a location of the UI control on the screen of the terminal, a wallpaper area block at a location corresponding to the location of the UI control may be captured from the acquired fuzzy wallpaper according to a location of the UI control on a touchscreen of the terminal; or, a wallpaper area block at a location that does not correspond to the location of the UI control is captured from the acquired fuzzy wallpaper according to a location of the UI control on a touchscreen of the terminal.

In specific implementation, in this embodiment of the present invention, the image capturing module 20 may capture one or more wallpaper area blocks from a fuzzy wallpaper, and when one wallpaper area block is captured, the wallpaper area block may be directly used in the setting of the setting module 30. When multiple (two or more) wallpaper area blocks are captured, in this embodiment of the present invention, the setting module 30 may set any captured wallpaper area block to a background of the UI control; or set the multiple captured wallpaper area blocks to a background of the UI control one by one according to a preset polling policy. The polling policy may include performing alternation in turn by time, for example, when it is assumed that three wallpaper area blocks (which are f0, f1, and f2, respectively) are captured, a policy of using the three wallpaper area blocks in turn as a background of a control a is: in a time segment t0, the wallpaper area block £0 is used as the background of the control a; in a time segment t1, the wallpaper area block f1 is used as the background of the control a; and in a time segment t2, the wallpaper area block f2 is used as the background of the control a. Alternatively, the polling policy may include performing alternation in turn according to different locations of a UI control, for example, wallpaper area blocks are still f0, f1, and f2, and the policy of performing polling according to the locations may be: when a control a is at a location (x0, y0), the wallpaper area block f0 is used as a background of the control a; when the control a moves to a location (x1, y1), the wallpaper area block f1 is used as the background of the control a; and when the control a is at a location (x2, y2), the wallpaper area block f2 is used as the background of the control a. Alternatively, the polling policy may be any other manner that can implement alternation, for example, for a live wallpaper, because the wallpaper is dynamically changeable, in this embodiment of the present invention, wallpaper area blocks of the live wallpaper in wallpaper states at different moments may be used as alternation materials of a background of a UI control. For example, if wallpaper area blocks of a live wallpaper in a top area of the live wallpaper at three moments, namely, t1, t0, and t2, are f00, f01, and f02, respectively, it may be set: when a control a is at a location (x0, y0), the wallpaper area block f00 is used as a background of the control a; when the control a moves to a location (x1, y1), the wallpaper area block f01 is used as the background of the control a; and when the control a is at a location (x2, y2), the wallpaper area block f02 is used as the background of the control a.

In this embodiment of the present invention, a location of a UI control may be indicated by using absolute coordinates of the UI control on the screen of the terminal or corner coordinates of an area block at which the UI control is located. In addition, a wallpaper area block corresponding to the location of the UI control or a wallpaper area block at a location that does not correspond to the location of the UI control is captured from the fuzzy wallpaper according to the extracted absolute coordinates and corner coordinates. Capturing one wallpaper area block at a corresponding location as the background of the UI control is used below as an example for description. FIG. 2a to FIG. 2c are used as an example, where in FIG. 2a, a tab area is a display area of a UI control of an Android system (this area includes three selection tags, such as Dial, Contact, and Message, as UI controls), and in this example, coordinates of four corners of the tab area may be used to indicate locations of the UI controls of the whole tab area. Therefore, in FIG. 2b, in this embodiment of the present invention, an area enclosed by coordinates that are the same as the coordinates of the four corners of the tab area may be captured from the whole acquired fuzzy wallpaper to serve as a captured wallpaper area block (specifically, an area shown in a black block in FIG. 2b), and a finally captured wallpaper area block corresponding to the tab area is shown in FIG. 2c. A capturing manner by using the absolute coordinates is similar to a capturing manner by using the corner coordinates, and details are not described herein again.

In a feasible implementation manner, after the image capturing module 20 captures a wallpaper area block from the fuzzy wallpaper, a black mask may also be superposed on the captured wallpaper area block, so that it can be ensured that the UI control on the wallpaper can be normally displayed on a wallpaper of any color (for example, a pure white wallpaper).

In specific implementation, in a feasible implementation manner, the setting module 30 may be specifically configured to set the one captured wallpaper area block to a background of the UI control by using a UI control background callback function. In specific implementation, the background callback function is a type of function for calling internal data of a terminal, and this background callback function is used for instructing an internal setting module of the terminal to set the one captured wallpaper area block to a background of the UI control. Certainly, in specific implementation, the internal setting module of the terminal may also be instructed by using some other terminal call functions to set the one captured wallpaper area block to a background of the UI control, and the call functions are not described one by one by using examples herein.

As described above, in difference embodiments, according to different quantities of one or more wallpaper area blocks captured from the fuzzy wallpaper by the image capturing module 20, the one wallpaper area block used may be different when the setting module 30 sets the one captured wallpaper area block to the background of the UI control.

As shown in FIG. 7, in some other feasible implementation manners, the apparatus for setting a background of a UI control according to the present invention may further include:

a sampling module 60, configured to sample the fuzzy wallpaper acquired by the acquisition module 10 and form a new fuzzy wallpaper from sampled data, where

when the image capturing module 20 captures, according to a location of the UI control on a screen of the terminal, a wallpaper area block from the acquired fuzzy wallpaper, the image capturing module 20 captures a wallpaper area block from the new fuzzy wallpaper formed from the data sampled by the sampling module 201. Likewise, when a wallpaper area block is captured from the new fuzzy wallpaper formed from the sampled data, a wallpaper area block at a location corresponding to the location of the UI control may be captured, according to a location of the UI control on a screen of the terminal, from the new fuzzy wallpaper formed from the sampled data; or, a wallpaper area block at a location that does not correspond to the location of the UI control is captured, according to a location of the UI control on a touchscreen of the terminal, from the new fuzzy wallpaper formed from the sampled data.

The image capturing module 20 in FIG. 7 differs from the image capturing module 20 in FIG. 4 merely in capturing an area block from a new fuzzy wallpaper formed from sampled data, and capturing an area block from a wallpaper that is not sampled. However, specific implementations of image capturing of the image capturing module 20 (refer to the description on the image capturing module 20 for details), for example, a manner of using absolute coordinates or corner coordinates of an area bock, are all the same, and details are not described herein again.

It can be seen from above that, the apparatus for setting a background of a UI control of this embodiment of the present invention sets a background of a UI control to be dynamically updated and set along with a wallpaper of a terminal. In this way, when the wallpaper of the terminal changes, the background of the UI control also changes in real time. Therefore, flexibility and variability of a background image of the UI control are enhanced in this embodiment of the present invention. Furthermore, in this embodiment of the present invention, to avoid performing fuzzy processing on a wallpaper only when a fuzzy wallpaper is acquired each time, when one wallpaper is generated, fuzzy processing may be performed on the generated wallpaper, and the fuzzy wallpaper obtained after the fuzzy processing is cached in internal memory of the terminal or saved in a memory of the terminal. In this way, when a fuzzy wallpaper needs to be acquired to serve as the background of the UI control, the fuzzy wallpaper may be directly acquired and an area block of the fuzzy wallpaper may be captured, so that a processing time for setting, by a system, the background of the UI control can be reduced. Moreover, loss of the internal memory of the terminal may be reduced by using the memory to save the fuzzy wallpaper. Besides, in the embodiments of the present invention, a black mask may also be superposed on the captured wallpaper area to ensure that the UI control on the wallpaper can be normally displayed on a wallpaper of any color. In addition, in the embodiments of the present invention, when a wallpaper area is captured, the whole fuzzy wallpaper may be also first sampled, and a size of the wallpaper area captured after the sampling is smaller, which may further reduce the loss of the internal memory of the terminal and save space of the internal memory.

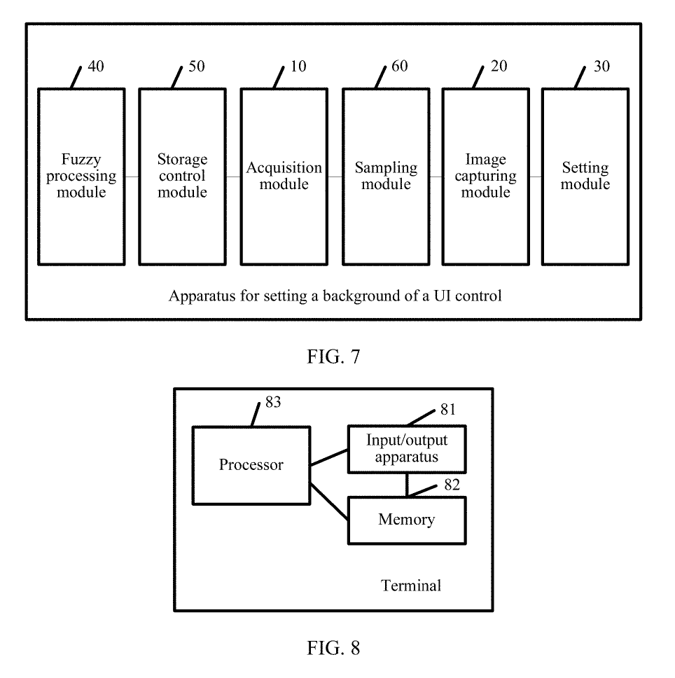

FIG. 8 is a schematic structural composition diagram of an embodiment of a terminal according to the present invention. This terminal may be configured to execute a process of the method according to FIG. 1. Reference may be made to discussion on the method embodiment for same or corresponding special technical features of the terminal. In this embodiment, hardware composition of an apparatus for setting a background of a UI control is exemplified. As shown FIG. 8, the terminal may include an input/output apparatus 81, a memory 82, and a processor 83, where the input/output apparatus 81, the memory 82, and the processor 83 are connected by using a bus.

The input/output apparatus 81 is configured to interact with a user and receive an instruction input by the user or output data to the user. In specific implementation, the input/output apparatus 81 of this embodiment of the present invention may be an input/output apparatus such as a keyboard, a mouse, a photoelectric input apparatus, a sound input apparatus, a touch-based input apparatus, a scanner, a display, a speaker, or a printer.

The memory 82 is configured to save program data having various functions. In this embodiment of the present invention, the data stored in the memory 82 includes a fuzzy wallpaper, and program data that can be called and run by the processor 83. In specific implementation, the memory 82 of this embodiment of the present invention may be a system memory, for example, a volatile memory (such as a RAM), a nonvolatile memory (such as a ROM or a flash memory), or a combination thereof. In specific implementation, the memory 82 of this embodiment of the present invention may also be an external memory outside the system, for example, a magnetic disk, an optical disc, or a magnetic tape.

The processor 83 is configured to call the program data stored in the memory 82 and perform the following operations: acquiring, after a wallpaper of a terminal is updated, a fuzzy wallpaper obtained after fuzzy processing is performed on the updated wallpaper; capturing, according to a location of the UI control on a screen of the terminal, a wallpaper area block from the acquired fuzzy wallpaper; and setting the one captured wallpaper area block to a background of the UI control.

In some feasible implementation manners, the wallpaper includes a live wallpaper, and the processor 83 performs the operation of acquiring a fuzzy wallpaper obtained after fuzzy processing is performed on the updated wallpaper, which specifically includes:

acquiring a fuzzy wallpaper obtained after fuzzy processing is performed on each changing state of an updated live wallpaper.

In some feasible implementation manners, the processor 83 performs the operation of capturing, according to a location of the UI control on a screen of the terminal, a wallpaper area block from the acquired fuzzy wallpaper, which specifically includes : capturing, according to a location of the UI control on a touchscreen of the terminal, a wallpaper area block at a location corresponding to the location of the UI control from the acquired fuzzy wallpaper.

In some feasible implementation manners, when the processor 83 performs the operation of capturing a wallpaper area block from the acquired fuzzy wallpaper, multiple wallpaper area blocks are captured; and then the processor 83 performs the operation of setting the one captured wallpaper area block to a background of the UI control, which specifically includes: setting any wallpaper area block of the multiple captured wallpaper area blocks to the background of the UI control; or, setting the multiple wallpaper area blocks to the background of the UI control one by one according to a preset polling policy.

In some feasible implementation manners, the processor 83 further performs the following operation: before acquiring, after the wallpaper of the terminal is updated, a fuzzy wallpaper obtained after fuzzy processing is performed on the updated wallpaper, performing fuzzy processing on the updated wallpaper; or, when the terminal generates one wallpaper, performing fuzzy processing on the generated wallpaper.

In some feasible implementation manners, the processor 83 further performs the following operation: caching the fuzzy wallpaper obtained after the fuzzy processing is performed in internal memory of the terminal or saving the fuzzy wallpaper in a memory of the terminal, so as to acquire the fuzzy wallpaper obtained after fuzzy processing is performed on the updated wallpaper.

In some feasible implementation manners, before the processor 83 performs the operation of capturing, according to a location of the UI control on a screen of the terminal, a wallpaper area block from the acquired fuzzy wallpaper, the processor 83 further performs the following operations:

sampling the acquired fuzzy wallpaper and forming a new fuzzy wallpaper from sampled data; and

then, when the processor performs the operation of capturing, according to a location of the UI control on a screen of the terminal, a wallpaper area block from the acquired fuzzy wallpaper, capturing a wallpaper area block from the new fuzzy wallpaper formed from the sampled data.

In some feasible implementation manners, after the processor 83 performs the step of capturing a wallpaper area block from the fuzzy wallpaper, the processor 83 further performs the following step: superposing a black mask on the captured wallpaper area block.

In addition, an embodiment of the present invention further provides a computer storage medium, where the computer storage medium may store a program, and, when the program is executed, a part or all of the steps of method according to the embodiment of the present invention may be performed. In specific implementation, the computer storage medium according to this embodiment of the present invention includes: a RAM, a ROM, an EEPROM, a flash memory, a CD-ROM, a DVD or another optical memory, a magnetic tape, a magnetic disk or another magnetic memory, or any other medium that can be configured to save required information and that can be accessed by a computer device.

Obviously, a person skilled in the art can make various modifications and variations to the present invention without departing from the spirit and scope of the present invention. The present invention is intended to cover these modifications and variations provided that they fall within the scope of protection defined by the following claims and their equivalent technologies.

The foregoing descriptions are merely exemplary embodiments of the present invention, but are not intended to limit the protection scope of the present invention. Any equivalent modifications made according to the claims of the present invention still fall within the scope of the present invention.

1-22. (canceled)

23. A method for setting a background of a user interface (UI) control, the method comprising:
acquiring, after a wallpaper of a terminal is updated, a fuzzy wallpaper obtained after fuzzy processing is performed on the updated wallpaper;
capturing, according to a location of the UI control on a screen of the terminal, a wallpaper area block from the acquired fuzzy wallpaper; and
setting the captured wallpaper area block to a background of the UI control.

24. The method according to claim 23, wherein:
the wallpaper comprises a live wallpaper; and
acquiring a fuzzy wallpaper obtained after fuzzy processing is performed on the updated wallpaper comprises:
acquiring a fuzzy wallpaper obtained after fuzzy processing is performed on each changing state of an updated live wallpaper.

25. The method according to claim 23, wherein:
capturing, according to a location of the UI control on a screen of the terminal, a wallpaper area block from the acquired fuzzy wallpaper comprises:
capturing, according to a location of the UI control on a touchscreen of the terminal, a wallpaper area block at a location corresponding to the location of the UI control from the acquired fuzzy wallpaper.

26. The method according to claim 23, wherein:
capturing, according to a location of the UI control on a screen of the terminal, a wallpaper area block from the acquired fuzzy wallpaper comprises:
capturing multiple wallpaper area blocks; and
setting the captured wallpaper area block to a background of the UI control comprises:
setting any wallpaper area block of the multiple captured wallpaper area blocks to the background of the UI control, or
setting the multiple wallpaper area blocks to the background of the UI control one by one according to a preset polling policy.

27. The method according to claim 23, further comprising:
before acquiring, after a wallpaper of a terminal is updated, a fuzzy wallpaper obtained after fuzzy processing is performed on the updated wallpaper, performing fuzzy processing on the updated wallpaper; or
when the terminal generates one wallpaper, performing fuzzy processing on the generated wallpaper.

28. The method according to claim 27, further comprising:
caching the fuzzy wallpaper obtained after the fuzzy processing is performed in internal memory of the terminal or saving the fuzzy wallpaper in a memory of the terminal, so as to acquire the fuzzy wallpaper obtained after fuzzy processing is performed on the updated wallpaper.

29. The method according to claim 23, wherein before capturing, according to a location of the UI control on a screen of the terminal, a wallpaper area block from the acquired fuzzy wallpaper, the method further comprises:
sampling the acquired fuzzy wallpaper and forming a new fuzzy wallpaper from sampled data; and
during the capturing, according to a location of the UI control on a screen of the terminal, a wallpaper area block from the acquired fuzzy wallpaper, capturing a wallpaper area block from the new fuzzy wallpaper formed from the sampled data.

30. An apparatus for setting a background of a user interface (UI) control, the apparatus comprising:
an acquisition module, configured to acquire, after a wallpaper of a terminal is updated, a fuzzy wallpaper obtained after fuzzy processing is performed on the updated wallpaper;
an image capturing module, configured to capture, according to a location of the UI control on a screen of the terminal, a wallpaper area block from the fuzzy wallpaper acquired by the acquisition module; and
a setting module, configured to set the wallpaper area block captured by the image capturing module to a background of the UI control.

31. The apparatus according to claim 30, wherein:
the wallpaper comprises a live wallpaper; and
the acquisition module is configured to: after the wallpaper of the terminal is updated, acquire a fuzzy wallpaper obtained after fuzzy processing is performed on each changing state of an updated live wallpaper.

32. The apparatus according to claim 30, wherein the image capturing module is configured to capture, according to a location of the UI control on a touchscreen of the terminal, a wallpaper area block at a location corresponding to the location of the UI control from the fuzzy wallpaper acquired by the acquisition module.

33. The apparatus according to claim 30, wherein:
when the image capturing module captures a wallpaper area block from the fuzzy wallpaper acquired by the acquisition module, multiple wallpaper area blocks are captured; and
the setting module is configured to:
set any wallpaper area block of the multiple captured wallpaper area blocks to the background of the UI control,
or set the multiple wallpaper area blocks to the background of the UI control one by one according to a preset polling policy.

34. The apparatus according to claim 30, further comprising:
a fuzzy processing module, configured to:
before the acquisition module acquires, after the wallpaper of the terminal is updated, a fuzzy wallpaper obtained after fuzzy processing is performed on the updated wallpaper, perform fuzzy processing on the updated wallpaper; or
when the terminal generates one wallpaper, perform fuzzy processing on the generated wallpaper.

35. The apparatus according to claim 30, further comprising:
a sampling module, configured to: sample the fuzzy wallpaper acquired by the acquisition module and form a new fuzzy wallpaper from sampled data, wherein when the image capturing module captures, according to a location of the UI control on a screen of the terminal, a wallpaper area block from the acquired fuzzy wallpaper, the image capturing module captures a wallpaper area block from the new fuzzy wallpaper formed from the sampled data.

36. A terminal, comprising:
an input/output apparatus configured to interact with a user and receive an instruction input by the user or output data to the user;
a memory configured to save program data having various functions; and
a processor, coupled to the memory and the input/output apparatus via a bus, configured to call program data stored in the memory which, when executed by the processor, cause the processor to:
acquire, after a wallpaper of a terminal is updated, a fuzzy wallpaper obtained after fuzzy processing is performed on the updated wallpaper;
capture, according to a location of a user interface (UI) control on a screen of the terminal, a wallpaper area block from the acquired fuzzy wallpaper; and
setting the captured wallpaper area block to a background of the UI control.

37. The terminal according to claim 36, wherein:
the wallpaper comprises a live wallpaper; and
the processor is further configured to call program data stored in the memory which, when executed by the processor, cause the processor to
acquire a fuzzy wallpaper obtained after fuzzy processing is performed on each changing state of an updated live wallpaper.

38. The terminal according to claim 36, wherein the processor is further configured to call program data stored in the memory which, when executed by the processor, cause the processor to:
capture, according to a location of the UI control on a touchscreen of the terminal, a wallpaper area block at a location corresponding to the location of the UI control from the acquired fuzzy wallpaper.

39. The terminal according to claim 36, wherein the processor is further configured to call program data stored in the memory which, when executed by the processor, cause the processor to:
capture multiple wallpaper blocks; and
set any wallpaper area block of the multiple captured wallpaper area blocks to the background of the UI control, or set the multiple wallpaper area blocks to the background of the UI control one by one according to a preset polling policy.

40. The terminal according to claim 36, wherein the processor is further configured to call program data stored in the memory which, when executed by the processor, cause the processor to:
perform fuzzy processing on the updated wallpaper; or
when the terminal generates one wallpaper, performing fuzzy processing on the generated wallpaper.

41. The terminal according to claim 40, wherein the processor is further configured to call program data stored in the memory which, when executed by the processor, cause the processor to:
cache the fuzzy wallpaper obtained after the fuzzy processing is performed in internal memory of the terminal or saving the fuzzy wallpaper in a memory of the terminal, so as to acquire the fuzzy wallpaper obtained after fuzzy processing is performed on the updated wallpaper.

42. The terminal according to claim 36, wherein the processor is further configured to call program data stored in the memory which, when executed by the processor, cause the processor to:
sample the acquired fuzzy wallpaper and forming a new fuzzy wallpaper from sampled data; and
capture a wallpaper area block from the new fuzzy wallpaper formed from the sampled data.
